(19) United States
(12) Patent Application Publication
(10) Pub. No.: US 2025/0360621 A1
(43) Pub. Date: Nov. 27, 2025

(54) System And Methods For Feeding Containers And Caps Into A Filling Line And A Capping Line Using Vision-Guided Robotics

(71) Applicant: Viena Inc., Cupertino, CA (US)

(72) Inventor: Sankar Narayana Kondur, Cupertino, CA (US)

(73) Assignee: Viena Inc., Cupertino, CA (US)

(21) Appl. No.: 19/218,566

(22) Filed: May 26, 2025

Related U.S. Application Data
(60) Provisional application No. 63/652,011, filed on May 26, 2024.

(51) Int. Cl. B25J 9/16; B25J 9/00; B25J 19/04

(52) U.S. Cl. CPC B25J 9/1669; B25J 9/0093; B25J 19/04

(57) ABSTRACT

Improved methods and a system for feeding containers and caps into a filling line and a capping line are provided. A 3D vision inspection system identifies a container located proximal to a top of a heap within a containers bin. A first set of robotic arms picks the identified container, places it onto a conveyor input in an upright orientation with the open end of the container facing upwards. The container is then transferred into a conveyor or accumulation table for transport to a filling station. Similarly, a third 3D camera identifies caps within a caps bin. A second set of robotic arms picks the identified caps, places them onto an alignment station, and orients them for placement into the capping line. The system incorporates Artificial Intelligence (AI)-based computer vision models for object identification and orientation, enhancing the reliability and efficiency of automated bottling and capping operations.

### CROSS-REFERENCE TO RELATED APPLICATIONS

This application claims priority to and the benefit of the provisional patent application titled “Method Of Feeding Bottles And Caps Into A Filling And Capping Line”, application No. 63/652,011, filed in the United States Patent and Trademark Office on May 26, 2024. The specification of the above referenced patent application is incorporated herein by reference in its entirety.

### FIELD OF THE INVENTION

The present invention relates generally to the field of automated bottling and capping processes. More specifically, it pertains to an innovative method and system for feeding containers and caps into a filling line and a capping line using robotic arms guided by a computer vision system.

### BACKGROUND OF THE INVENTION

In conventional bottling and capping processes, bottles and caps are typically aligned and fed into filling and capping lines through a combination of mechanical feeders, rotating drums, spirals, and gravity-fed chutes. The steps generally include dumping caps into a rotating drum, lifting and aligning them through mechanical or centrifugal force, and discarding misaligned caps.

Similarly, bottles, vials and similar containers are aligned and stored using comparable mechanical methods. Despite widespread use, such systems often suffer from inefficiencies. Misalignment of bottles or caps can frequently occur, leading to jams or stoppages that necessitate halting the production line. These interruptions result in significant operational downtime, increased maintenance requirements, and decreased overall throughput.

Additionally, the repetitive mechanical stress from frequent starts and stops can accelerate wear and tear on machinery, shortening equipment lifespan and increasing replacement costs. Furthermore, manual intervention is frequently required to clear jams.

Accordingly, there is a long-felt yet unresolved need for an improved system and methods of aligning and feeding bottles and caps into filling and capping lines.

### SUMMARY OF THE INVENTION

The system and methods disclosed herein address the above recited need for improved system and methods of aligning and feeding bottles and caps into filling and capping lines. The present invention provides innovative and improved methods and a system for feeding bottles and caps into a filling line and a capping line, respectively, using vision-guided robotics and computer vision technology. The system leverages modern technologies comprising computer vision, Artificial Intelligence (AI), and robotics. The system addresses the inefficiencies in conventional bottling and capping processes by providing intelligent detection, orientation, and placement of bottles and caps, thereby enhancing automation reliability and operational efficiency.

The system utilizes a 3-dimensional (3D) vision inspection setup comprising multiple 3D cameras strategically positioned over the containers bin, caps bin, and conveyor input. As used herein, a container may refer to a bottle, vial, etc.

The methods comprise a method for feeding containers into a filling line. The method for feeding containers into the filling line comprises identifying a container, for example, a bottle or a vial, located proximal to a top of a heap within a containers bin using a first 3D camera of a 3D vision inspection system, picking the identified container using a first set of robotic arms, and placing the picked container onto either a conveyor input or in an accumulation table with the container in an upright orientation. In the upright position of the container, the open end of the container faces upwards. The method further comprises identifying a 3D position of an input of a conveyor for transporting the upright container to a filling station using a second 3D camera of the 3D vision system. The upright container is then placed into the conveyor input for subsequent filling operations while maintaining the upright orientation of the container with the open end facing upwards.

The methods further comprise a method for feeding caps into a capping line. Similar to the method for feeding containers into the filling line, the caps proximal to a top of a heap within a caps bin are identified using a third 3D camera of the 3D vision inspection system. A second set of robotic arms picks the identified caps, places them at an alignment station in either a vertical orientation or a slant orientation. In the next step of the method, the aligned caps are subsequently placed into the capping line with the closed surface of the caps facing an upward direction.

The system for feeding a plurality of containers and a plurality of caps into a filling line and a capping line comprises a containers bin configured to hold a heap of containers, a caps bin configured to hold a heap of caps, an alignment station configured to align the cap, a 3D vision inspection system comprising at least three 3D cameras, a first set of robotic arms configured to pick and align the containers, and a second set of robotic arms configured to pick and align the caps.

The system incorporates Artificial Intelligence (AI)-based training of computer vision models for object detection and pose estimation, enabling more accurate identification, orientation, and placement of the containers and caps. This approach minimizes production downtime, increases system reliability, and provides a scalable solution for a wide range of container and cap types.

Moreover, AI models can continuously learn and adapt to new patterns or anomalies in real-time, improving accuracy over time without requiring manual recalibration. This adaptability makes the system resilient to variations in lighting. The use of AI also supports data-driven optimization, providing insights into bottlenecks, error rates, and efficiency trends, thereby empowering operators to make informed decisions that enhance overall productivity.

These and further features of the present invention will be apparent with reference to the following description and drawings. In the description and drawings, particular embodiments of the invention have been disclosed in detail as being indicative of some of the ways in which the principles of the invention may be employed, but the invention is not limited correspondingly in scope. Rather, the invention includes all changes, modifications and equivalents coming within the spirit and terms of the claims.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and system components disclosed herein. The description of a method step or a system component referenced by a numeral in a drawing is applicable to the description of that method step or system components shown by that same numeral in any subsequent drawing herein.

FIG. 1 illustrates a method for feeding a plurality of containers into a filling line.

FIG. 2 illustrates a method for feeding a plurality of caps into a capping line.

FIG. 3 illustrates a system for feeding a plurality of containers and a plurality of caps into a filling line and a capping line.

FIG. 4 illustrates an architecture diagram of the 3D vision inspection system showing signal flow between all components of the 3D vision inspection system.

FIGS. 5A and 5B illustrate training data comprising different bottle sizes with their contours identified.

FIGS. 5C and 5D illustrate inferenced images having the contours of the containers 301 identified and bounding box drawn around each container.

FIG. 6 illustrates another inferenced image having the contours of the containers identified and bounding box drawn around each container.

FIGS. 7A and 7B illustrate training data of different cap sizes with their contours identified.

FIGS. 8A and 8B illustrate inferenced images having the contours of the caps identified and bounding box drawn around each cap.

FIGS. 9A-9D illustrate a detailed flowchart of the method illustrated in FIG. 1.

### DETAILED DESCRIPTION OF THE PREFERRED EMBODIMENTS

The system and methods disclosed herein address the above recited need for improved system and methods for feeding containers and caps into a filling line and a capping line using robotic arms and a 3D vision inspection system. The system enhances the reliability and efficiency of conventional bottling and capping operations by using computer vision, Artificial Intelligence (AI), and precise robotic handling.

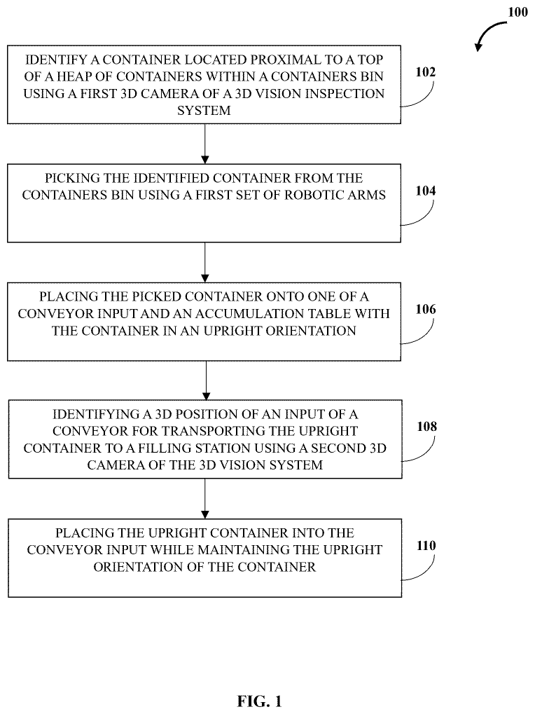

FIG. 1 illustrates a method 100 for feeding a plurality of containers into a filling line. As used herein, a container may refer to a bottle, vial, etc. The method 100 for feeding containers into the filling line comprises identifying 102 a container, for example, a bottle or a vial, located proximal to a top of a heap within a containers bin using a first 3D camera of a 3D vision inspection system. The method 100 further comprises picking 104 the identified container using a first set of robotic arms, and placing 106 the picked container onto either a conveyor input or in an accumulation table with the container in an upright orientation. In the upright position of the container, the open end of the container faces upwards. The method 100 further comprises identifying 108 a 3D position of an input of a conveyor for transporting the upright container to a filling station using a second 3D camera of the 3D vision system. The upright container is then placed 110 into the conveyor input for subsequent filling operations while maintaining the upright orientation of the container with the open end facing upwards.

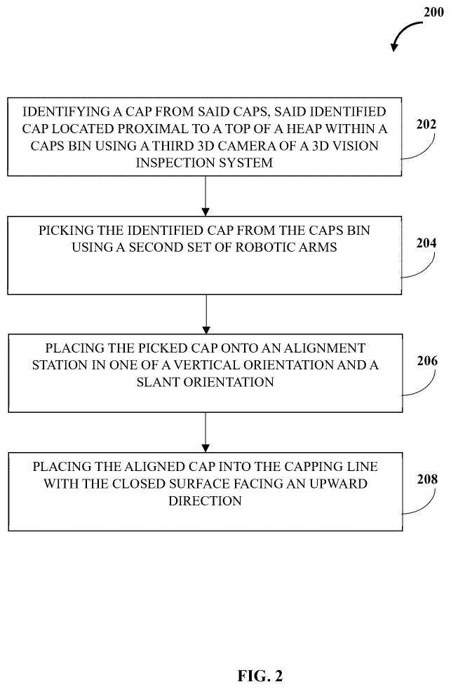

FIG. 2 illustrates a method 200 for feeding a plurality of caps into a capping line. Similar to the method 100 for feeding containers into the filling line, the caps proximal to a top of a heap within a caps bin are identified 202 using a third 3D camera of the 3D vision inspection system. The third 3D camera of the 3D vision inspection system may be positioned above the caps bin. A second set of robotic arms picks 204 the identified caps, places 206 them at an alignment station 316 in either a vertical orientation or a slant orientation. In the next step of the method 200, the aligned caps are subsequently placed 208 into the capping line with the closed surface of the caps facing an upward direction.

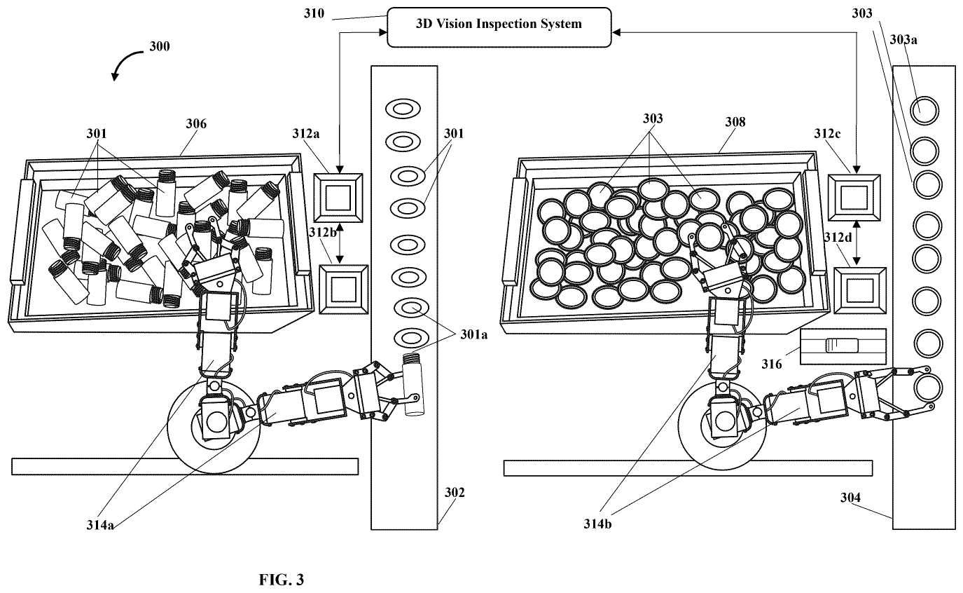

FIG. 3 illustrates a system 300 for feeding a plurality of containers 301 and a plurality of caps 303 into a filling line 302 and a capping line 304. The system 300 is used to implement the methods 100 and 200 illustrated in FIGS. 1 and 2. As shown in FIG. 3, the system 300 comprises a containers bin 306 configured to hold a heap of containers 301, a caps bin 308 configured to hold a heap of caps 303, an alignment station 316 configured to align the cap 303, a 3D vision inspection system 310 comprising at least three 3D cameras 312a, 312b, 312c and 312d. The system 300 further comprises a first set of robotic arms 314a and 314b configured to pick and align the containers 301 in an upright orientation and a second set of robotic arms 314b configured to pick and align the caps 303.

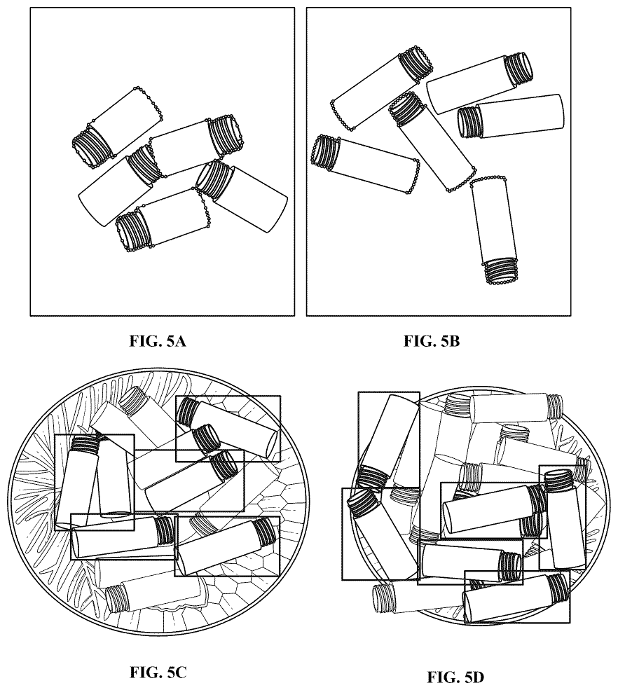

As shown in FIG. 3, a first 3D camera 312a of the 3D vision inspection system 310 is positioned above a containers bin 306, for example, a vial bin 306 containing a heap of containers 301, for example, vials or bottles. The 3D vision inspection system 310 identifies one of the containers 301 positioned on the top of the heap or closest to be picked up based on nearest to camera criteria. The 3D vision system 310 identifies a container 301 at the top of the heap based on height and accessibility criteria. The video feed from the 3D camera 312a is captured and converted to images. The containers 301 in the image are identified using computer vision AI models, called AI inferencing. Computer Vision AI models are used to identify the containers 301 on the top of the heap. The computer vision models are trained before-hand to identify the containers 301 and give the contours of the containers 301. This is called AI model training. The inferenced images will have the contours of the bottle identified, as shown in FIGS. 5A and 5B.

In an embodiment, the method may also comprise normalizing the image, detecting the edges, contours to analyze the image data using techniques like template matching to make sure the container 301 position is not changed. Using the AI trained models detect the container 301 and extract the bounding box co-ordinates and the segmented co-ordinates, as shown in FIGS. 5C and 5D. We then get the XYZ co-ordinates for each of these identified containers 301 from the 3D camera library. We then calculate the container 301 that is nearest to the camera 312a or the robotic arm 314a. The image captured with 3D camera 314a provides 3D representation of the environment, with each point having X, Y, Z coordinates and units in Millimeters or meters.

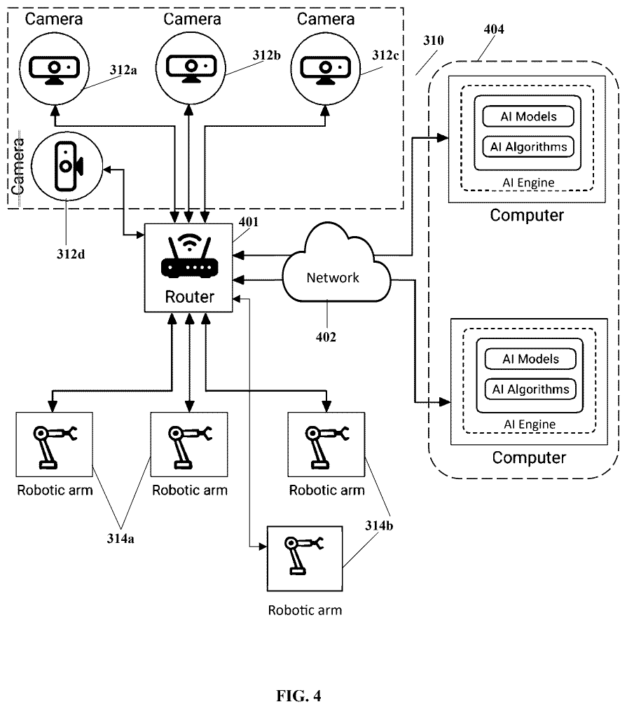

FIG. 4 illustrates an architecture diagram 400 of the 3D vision inspection system 310 showing signal flow between all components of the 3D vision inspection system 310. The 3D vision inspection system 310 is communicatively coupled to a network 402 via a router 401 to a computer system 404 configured to control one or more first set of robotic arms 314a, the second set of robotic arms 314b and the 3D vision inspection system 310 itself. As shown in FIG. 4, the 3D cameras 312a, 312b, 312c and 312d and the set of robotic arms 314a and 314b are also connected to the computer system 404 to the network 402 via the router 401. The computer system 404 controls the robotic arms 314a and 314b through TCP/IP messaging. The computer system 404 controls the cameras 312a and 312b and gets feed from them. The computer system 404 analyses the images of the containers 301 and controls the robotic arms 314a to pick up the container and place it on the conveyor system 302. It also analyses the position of the conveyor system 302 to place the container 301. The computer system 404 controls the cameras 312b and 312c and gets feed from them. The computer system 404 analyses the images of the caps 303 and controls the robotic arms 314b to pick up the cap 303 and place it on the conveyor system 304. It also analyses the position of the conveyor system 304 to place the caps 303. It should be noted that camera 312a is for detecting container 301s, camera 312b is for checking the conveyor system 302 where the containers 301 are placed, camera 312c is used to get feed from the caps bin 308, and camera 312d is for checking the alignment station 316 on which the caps 303 are placed and also for checking the conveyor system 304 in which the caps 304 are placed.

The computer system 404 sends messages to the robotic arms 314a and 314b using TCP/IP interface using the robotic arm specific protocol. Each manufacturer has a different way to control the robotic arm. The feed from the cameras 312a, 312b, 312c and 312d are captured using RTSP protocol over TCP/IP. The system 300 utilizes AI models and algorithms to detect containers 301 and caps 303.

The system 300 utilizes artificial intelligence to detect containers 301 and caps 303. For example, to identify the containers 301, the feed from the 3D camera 312a is captured and converted to images. The containers 301 in the image are identified using computer vision AI models, called AI inferencing. The computer vision models are trained before-hand to identify the containers 301 and give the contours of the containers 301, as shown in FIGS. 5A and 5B. FIGS. 5A and 5B illustrate training data comprising different bottle sizes with their contours identified.

### Below Are the Steps to be Followed to Train the AI Models

### Collect Data

a) Gather sufficient relevant data (images, video, etc.)

### Perform Data Preprocessing Like

a) Resize images
b) Normalize
c) Augment data (flip, rotate, blur, etc.)
d) Split dataset into train, validation, and test sets

### Annotation

a) Label the data using the annotation tools like cvat, labelme etc., according to the below requirement Detection Classification

### Model Selection or Custom Design

a) Choose the pretrained model or train the model from scratch

### Train the Model

a) Define parameters like learning rate, batch size, epochs and start the training

Below are the libraries used in training the AI model:
PyTorch
OpenCV
Numpy
Matplotlib
Albumentations

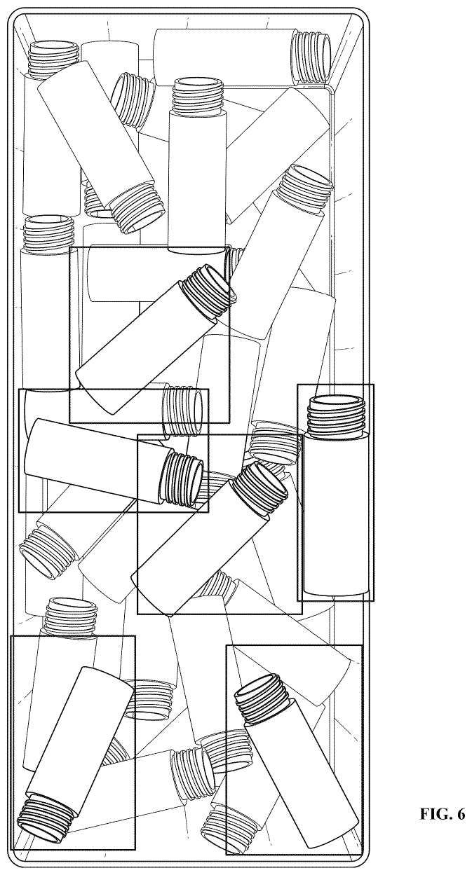

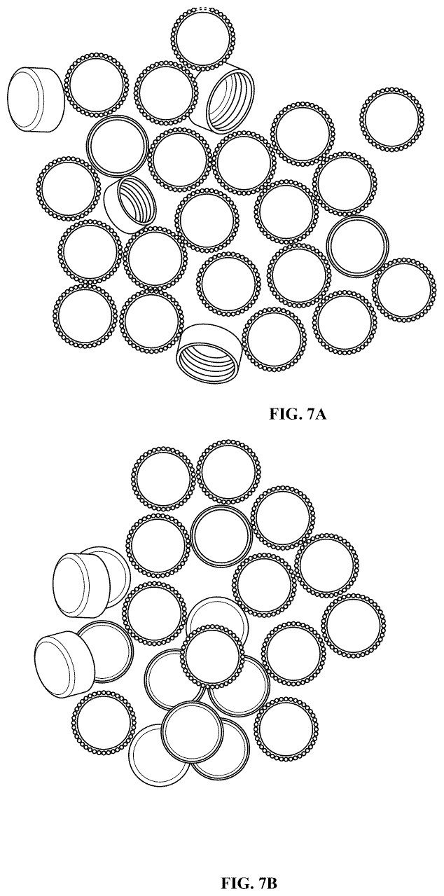

Using the AI trained models, the containers 301 are detected and the bounding box co-ordinates and the segmented co-ordinates are extracted. The inferenced images will have the contours of the containers 301 identified, as shown in FIGS. 5C and 5D. FIGS. 5C and 5D illustrate inferenced images having the contours of the containers 301 identified and bounding box drawn around each container 301. FIG. 6 illustrates another inferenced image having the contours of the containers 301 identified and bounding box drawn around each container 301.

In an embodiment, the method may also comprise normalizing the image, detecting the edges, contours to analyze the image data using techniques like template matching to make sure the container's 301 position is not changed. The X, Y, Z coordinates of the center of the interested container 301 from the 3D camera 312a are also obtained using the library provided by the 3D camera 312a manufacturer. Using the XYZ co-ordinates of the center and the size of the container 301 estimated using the contours identified, the location that the robotic arm 314a gripper has to go to and pick it up is identified. The XYZ co-ordinates are then passed to the robotic arm 314a using the library or the protocol specific to the robotic arm 314a. Upon identification, a robotic arm 314a equipped with a vial handling gripper picks the selected container 301 from the containers bin 306. The robotic arm 314a, as illustrated in FIG. 3, then places the picked container 301 onto the conveyor input 302 or accumulation table (not shown). The container 301 is placed such that the open end 301a of the container 301 faces upward. The robotic arm 314a may use soft grippers or adaptive end effectors to prevent damage to the container 301 during repositioning. The same process is followed for identifying and picking caps 303.

As described above, the method 100 includes identifying 108 the 3D position of the input of the conveyor 302 or an accumulation table (not shown) used for transporting aligned containers 301 to a filling station (not shown). The conveyor's 302 position can be pre-calibrated or dynamically detected using a second 3D camera 312b of the 3D vision inspection system 310. The images from the second 3D camera 312b is used to identify the sides of the conveyor 302 and calculate that the position of the center of conveyor 302. The sides of the conveyor 302 are identified using trained AI models that identify the sides of the conveyor 302 and also using standard computer vision algorithms. In another embodiment, the aligned containers 301 are stored temporarily on an accumulation table (not shown) before being fed into the filling station (not shown).

As explained in FIG. 2, the method 200 uses a similar setup as method 100 for handling caps 303. A 3D camera 312c of the 3D vision inspection system 310 is positioned above the caps bin 308 containing a heap of caps 303. The video feed from the 3D camera 312c is captured and converted to images. The caps 303 in the image are identified using computer vision AI models, called AI inferencing. Computer Vision AI models are used to identify the caps 303 on the top of the heap. The computer vision models are trained before hand to identify the caps 303 and give the contours of the caps. FIGS. 7A and 7B illustrate training data of different cap sizes with their contours identified. FIGS. 7A and 7B comprise sample images included in the training data where the orientation pattern and depth factors are different for each image. The inferenced images will have the contours of the cap identified.

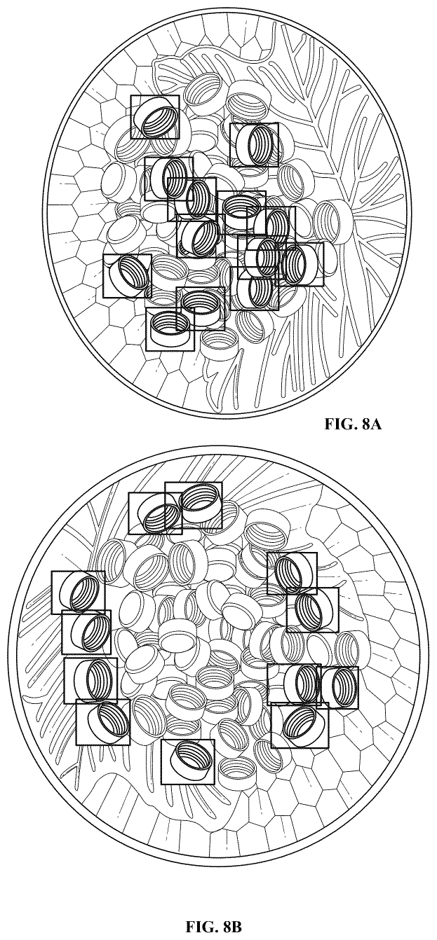

In an embodiment, the method may also comprise normalizing the image, detecting the edges, contours to analyze the image data using techniques like template matching to make sure the cap's 303 position is not changed. Using the AI trained models the cap is detected and the bounding box co-ordinates are extracted along with the segmented co-ordinates. FIGS. 8A and 8B illustrate inferenced images having the contours of the caps 303 identified and bounding box drawn around each cap 303. The X, Y, Z coordinates for each of these identified caps 303 are obtained from the 3D camera library.

The 3D vision inspection system 310 identifies a cap 303 located near the top of the heap. Upon identification, the second set of robotic arms 314b picks the identified caps 303 from the caps bin 308. Each cap 303 is placed in either a vertical or slant orientation onto an alignment station 316 designed for caps 303. Camera 312d is used for checking the alignment station 316 on which the caps 303 are placed.

After alignment, the cap 303 is picked again and placed into the capping line 304 using positional data obtained from a camera, for example, 312d, of the 3D vision inspection system 310. Camera 312d is also used for checking the conveyor system 304 in which the caps 304 are placed. The system 300 ensures that the closed surface 303a of the cap 303 faces upward, enabling efficient capping during subsequent operations.

Below is an example of positional data obtained from the camera, for example, 312c, the 3D vision inspection system 310:
XYZ values—0.049 m, 0.044 m, 0.273 m
These values are taken and using geometry the position the robotic end-effector gripper should go to is calculated in order to pick up the object.
These co-ordinates and commands are sent to the robotic arm, for example, 314b, using the robotic arm specific library or specific protocol.

### Computer Vision and Artificial Intelligence Integration

In an embodiment, the 3D vision inspection system 310 will incorporate AI-based models, such as convolutional neural networks (CNNs), trained to detect and classify containers 301 and caps 303. Training data may include depth images and point clouds of the objects in various orientations, as shown in FIGS. 5A-5B. Images similar to FIGS. 5A-5B are taken for training and the contours of the bottles are marked, as shown in FIGS. 5A-5B, and the model, for, example, a YoloV12 (CNN) model is trained using the training data. Once the model is trained, the model is used to infer (find/identify/predict) the containers 301 in the images that needs to be identified. The images are obtained from camera 314a.

The 3D vision inspection system 310 calculates critical spatial information, including height, distance, and position of the containers 301, caps 303, and conveyor 302 and 304 input, enabling precise robotic manipulation and placement. This automation reduces downtime caused by misalignment and increases production line throughput.

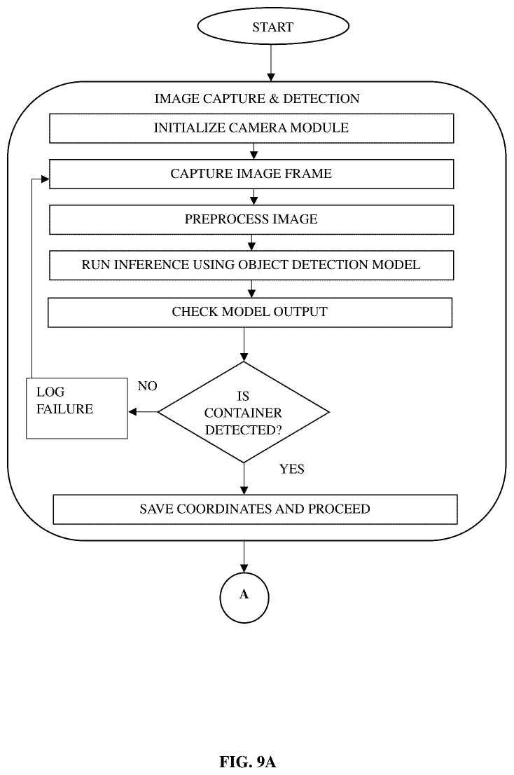

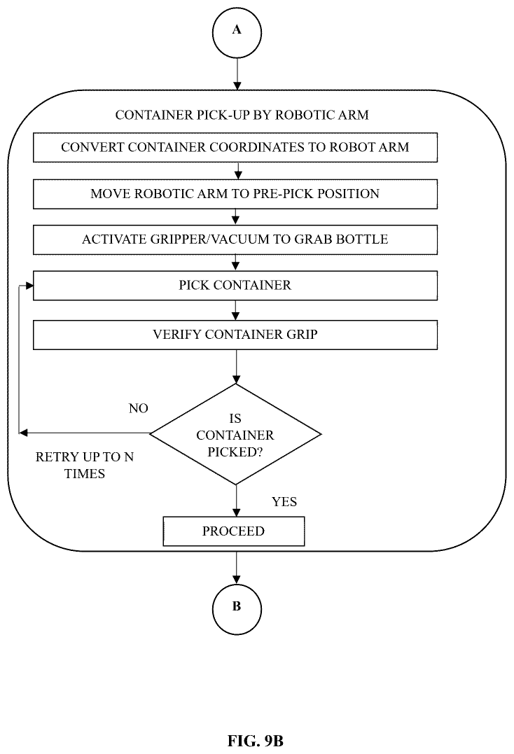

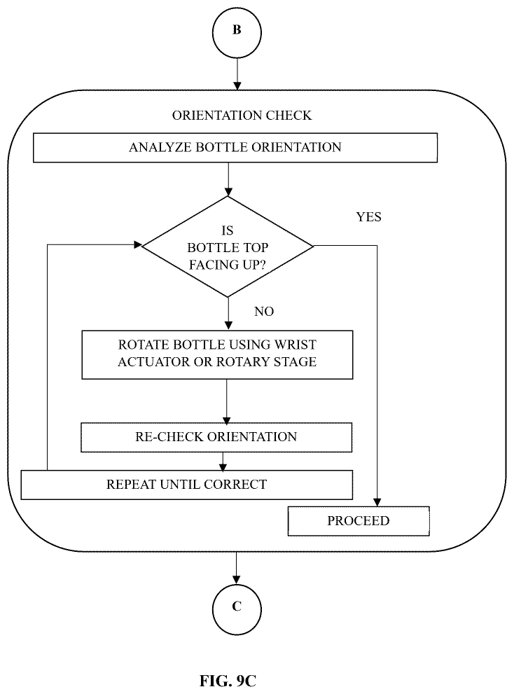

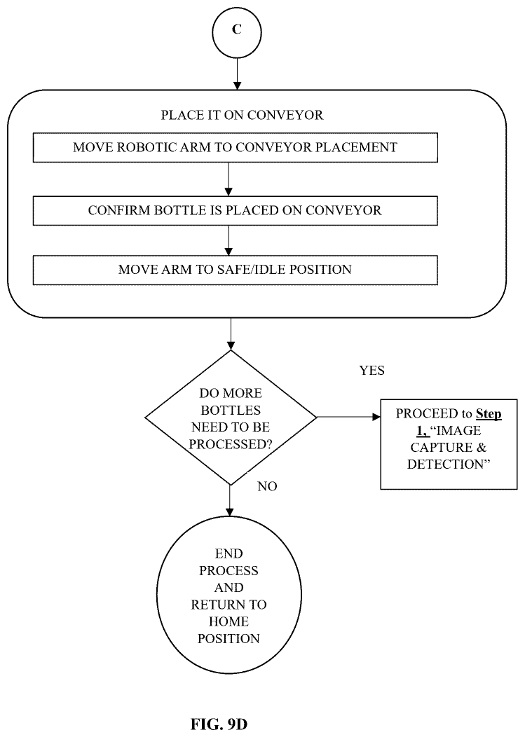

FIGS. 9A-9D illustrate a detailed flowchart of the method illustrated in FIG. 1.

### Step 1: Image Capture & Detection

Initialize camera module
Capture image frame
Preprocess image (e.g., resizing, normalization)
Run inference using object detection model
Check model output:
   If bottle detected→Save coordinates, proceed
If no bottle→Log failure, loop back to capture

### Step 2: Bottle Pick-Up by Robotic Arm

Convert bottle coordinates to robot arm coordinates
Move robotic arm to pre-pick position
Activate gripper/vacuum to grab bottle
Pick bottle
Verify bottle grip:
   If bottle not picked→Retry up to N times
   If bottle picked→Proceed

### Step 3: Orientation Check

Analyze bottle orientation
Check if bottle top is facing up:
   If yes→Proceed
   If no→
a. Rotate bottle using wrist actuator or rotary stage
b. Re-check orientation
c. Repeat until correct

### Step 4: Place It on Conveyor

Move robotic arm to conveyor placement position
Confirm bottle is placed on conveyor
Move arm to safe/idle position

### Step 5: Loop

Check if more bottles are to be processed
If yes→Loop back to step 1
If no→End process and return arm to home position

Although the system 300 has been described with specific reference to containers 301, more specifically to vials and bottles, and caps 303, it is understood that the methods 100 and 200 are applicable to a wide variety of containers and closure types. Furthermore, alternative robotic systems, such as SCARA robots, delta robots, or 6-axis articulated arms, may be employed depending on specific line requirements. Different types of 3D vision sensors, such as structured light cameras, stereo cameras, or time-of-flight sensors, may also be utilized based on operational constraints and accuracy requirements. The system architecture is scalable and can be integrated into both inline high-speed production environments and standalone quality control stations. Robotic end-effectors can be customized with interchangeable grippers or suction mechanisms to handle a diverse range of container geometries and fragility levels.

I claim:

1. A method for feeding a plurality of containers into a filling line, comprising:
identifying a container from said containers, said identified container located proximal to a top of a heap of said containers within a containers bin using a first 3D camera of a 3D vision inspection system;
picking the identified container from the containers bin using a first set of robotic arms;
placing the picked container onto one of a conveyor input and an accumulation table with the container in an upright orientation;
identifying a 3D position of an input of a conveyor for transporting the upright container to a filling station using a second 3D camera of the 3D vision system; and
placing the upright container into the conveyor input while maintaining the upright orientation of the container.

2. The method of claim 1, wherein the container is one of a bottle and a vial.

3. The method of claim 1, wherein the robotic arms comprise six-axis articulated robotic arms.

4. The method of claim 1, wherein the 3D vision system comprises structured light cameras, stereo vision cameras, or time-of-flight cameras.

5. The method of claim 1, wherein the conveyor input comprises an accumulation table.

6. The method of claim 1, further comprising rotating the container to correct misalignment.

7. The method of claim 1, wherein machine learning algorithms are used to prioritize the selection of easily accessible container to optimize pick efficiency.

8. A method for feeding a plurality of caps into a capping line, comprising:
identifying a cap from said caps, said identified cap located proximal to a top of a heap within a caps bin using a third 3D camera of a 3D vision inspection system;
picking the identified cap from the caps bin using a second set of robotic arms;
placing the picked cap onto an alignment station in one of a vertical orientation and a slant orientation; and
placing the aligned cap into the capping line with the closed surface facing an upward direction.

9. The method of claim 8, wherein the alignment station is configured to orient the caps in an upward direction.

10. The method of claim 8, wherein the placement of the cap into the capping line is based on positional data from the 3D vision system.

11. The method of claim 8, wherein the robotic arms are synchronized to minimize processing time between cap pickup and placement.

12. The method of claim 8, wherein the alignment of caps includes a flipping mechanism controlled by vision-guided robotics to ensure proper orientation.

13. A system for feeding a plurality of containers and a plurality of caps into a filling line and a capping line, comprising:
a containers bin configured to hold a heap of containers;
a caps bin configured to hold a heap of caps;
an alignment station configured to align the cap;
a 3D vision inspection system comprising at least three 3D cameras;
a first set of robotic arms configured to pick and align the containers in an upright orientation; and
a second set of robotic arms configured to pick and align the caps.

14. The system of claim 13, wherein the 3D vision inspection system is communicatively coupled to a central computer system configured to control the robotic arms and perform vision-based alignment.

15. The system of claim 13, wherein the 3D vision inspection system is trained using artificial intelligence models to detect and classify one of the containers and the caps.

16. The system of claim 13, further comprising one of a conveyor and an accumulation table positioned downstream of an alignment station.

17. The system of claim 13, wherein the first and second robotic arms operate simultaneously to feed the containers and the caps independently into the filling line and the capping line.
